(19) United States
(12) Patent Application Publication
(10) Pub. No.: US 2003/0082253 A1
(43) Pub. Date: May 1, 2003

(54) Mold for molding cake, steam bread, and the like

(76) Inventor: Wei-Hwang Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/984,480

(22) Filed: Oct. 30, 2001

(51) Int. Cl. A21C 3/00

(52) U.S. Cl. 425/89; 425/218; 249/168; 249/115

(57) ABSTRACT

A mold includes a bottom die, and an upper die closed on the bottom die and defining with the bottom die a cavity for folding molding food materials into a predetermined shape, the upper die having a coupling flange around the cavity and retaining means in the coupling flange, the bottom die having a coupling flange fitted into the coupling flange of the upper die, retaining means adapted for engaging the retaining means of the upper die, and an overflow outlet through which an overflow of inserted food passes to the outside of said mold.

### BACKGROUND OF THE INVENTION

The present invention relates to a food mold and, more particularly, to such a mold, which is comprised of a bottom die, and an upper die closed on the bottom die and defining with the bottom die a cavity for folding molding food materials into a predetermined shape.

In eastern culture, it is important to perform rites in honor of ancestors. More particularly in China or Chinese speaking countries, every family needs to offer a variety of sacrifices to gods and the deceased in particular days. Every offered sacrifice has a particular meaning. For example, the sacrifice of apple has the meaning of “peace”, the sacrifice of pineapple has the meaning of “goof fortune”; the sacrifice of glutinous rice cake eaten during lunar new year holidays has the meaning of “promotion advancing in rank every year”, etc. Further, cakes or steamed breads for use as sacrifices or other foodstuffs for particular purposes may have to be molded into a particular shape. For example, longevity peaches are made of flour in the shape of a peach and presented to another on his birthday. In this case, a particular mold shall be used.

### SUMMARY OF THE INVENTION

The present invention has been accomplished under the circumstances in view. It is the main object of the present invention to provide a mold, which is practical for molding dough and the like into a predetermined shape. According to the present invention, the mold comprises a bottom die, and an upper die closed on the bottom die and defining with the bottom die a cavity for folding molding food materials into a predetermined shape. The upper die comprises a coupling flange around the cavity and retaining means in the coupling flange. The bottom die comprises a coupling flange fitted into the coupling flange of the upper die, retaining means adapted for engaging the retaining means of the upper die, and an overflow outlet through which an overflow of inserted food passes to the outside of said mold. Further, a first thin sheet of stripping material and a second thin sheet of stripping material are respectively attached to the upper die and the bottom die around the cavity and adapted for adhering to the food material under molding and for protecting the molded food material against contamination.

### BRIEF DESCRIPTION OF THE DRAWINGS

FIG. 1 is an exploded view of a mold constructed according to a first embodiment of the present invention.

FIG. 2 is a sectional view of the first embodiment of the present invention showing the upper and the bottom die closed, food material filled in the cavity, an overflow of the food material passed out of the overflow outlet.

FIG. 3 is an enlarged view of a part of FIG. 2.

FIG. 4 is an exploded view of a mold constructed according to a second embodiment of the present invention.

FIG. 5 is a sectional view of the second embodiment of the present invention showing the upper die and the bottom die closed, food material filled in the cavity, an overflow of the food material passed out of the overflow outlet.

FIG. 6 is an enlarged scale of a part of FIG. 5.

FIG. 7 is an exploded view of a mold constructed according to a third embodiment of the present invention.

FIG. 8 is a sectional view of the third embodiment of the present invention showing the upper die and the bottom die closed, food material filled in the cavity, an overflow of the food material passed out of the overflow outlet.

FIG. 9 is an enlarged scale of a part of FIG. 8.

FIG. 10 illustrates a first thin sheet of stripper material and a second thin sheet of stripper material respectively used with the upper die and the bottom die of the mold of the first embodiment of the present invention.

FIG. 11 is a schematic drawing showing the first thin sheet of stripper material and the second thin sheet of stripper material adhered to the molded food material according to the present invention.

### DETAILED DESCRIPTION OF THE PREFERRED EMBODIMENT

Referring to FIGS. from 1 through 3, a mold 1 is shown for making cake, steamed bread, and the like in accordance with the first embodiment of the present invention. The mold 1 is comprised of an upper die 11 and a bottom die 12. When the upper die 11 and the bottom die 12 attached together, a cavity 2 is defined within the upper die 11 and the bottom die 12 for molding prepared dough into the desired shape. The upper die 11 and the bottom die 12 have a respective flat bearing wall 111 or 121 outwardly extended around the cavity 2. The upper die 11 has an endless coupling groove 112 formed in the bearing wall 111 around the cavity 2, and a sloping guide edge 1121 extended along the outer side of the endless coupling groove 112. The bottom die 12 has an endless coupling flange 122 formed in the bearing wall 111 around the cavity 2, and a sloping guide edge 1221 extended along the outer side of the endless coupling flange 122. When closing the upper die 11 and the bottom die 12, the endless coupling flange 122 is engaged into the endless coupling groove 112. By means of the relative guidance of the sloping guide edges 1121 and 1221, the endless coupling flange 122 can easily be engaged into the endless coupling groove 112. The bottom die 12 further comprises an overflow outlet 123 through which an overflow of inserted dough 21, when leavened, flows to the outside of the mold 1. The upper die 11 further comprises a plurality of raised portions 1122 protruded from the bottom surface of the flat bearing wall 111 near the border of the flat bearing wall 111. When the upper die 11 and the bottom die 12 closed, the raised portions 1122 lift the border area of the flat bearing wall 111 of the upper die 11 from the flat bearing wall 121 of the bottom die 12, enabling the upper die 11 to be easily disconnected from the bottom die 12 after molding.

FIGS. from 4 through 6 show a second embodiment of the present invention. According to this embodiment, the upper die 11′ comprises a coupling flange 111′ extended around the cavity 2 of the mold 1′, and a plurality of raised retaining portions 112′ equiangularly protruded from the inner surface of the coupling flange 111′. The bottom die 12′ comprises a coupling flange 121′ extended around the cavity 2 of the mold 1′ and fitted into the coupling flange 111′ of the upper die 11′, a plurality of recessed retaining portions 122′ equiangularly formed in the outer surface of the coupling flange 121′ and respectively forced into engagement with the raised retaining portions 112′ of the upper die 11′, and an overflow outlet 123′ through which an overflow of inserted dough 21, when leavened, flows to the outside of the mold 1′.

FIGS. from 7 through 9 show a third embodiment of the present invention. According to this embodiment, the upper die 11″ comprises a coupling flange 111″ extended around the cavity 2 of the mold 1″, and a plurality of retaining rods 112″ equiangularly downwardly extended from the bottom surface of the coupling flange 111″. The bottom die 12″ comprises a coupling flange 121″ extended around the cavity 2 of the mold 1″ and fitted over the coupling flange 111″ of the upper die 11″, a plurality of retaining holes 122′ equiangularly formed in the coupling flange 121″ and respectively forced into engagement with the retaining rods 112″ of the upper die 11″, and an overflow outlet 123″ through which an overflow of inserted dough 21, when leavened, flows to the outside of the mold 1″.

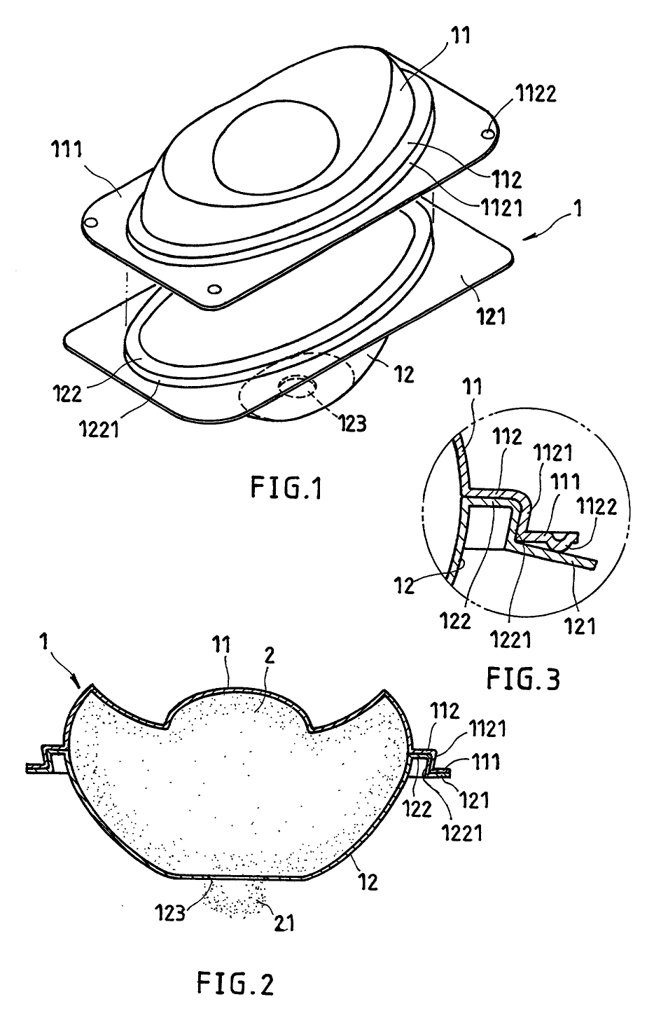

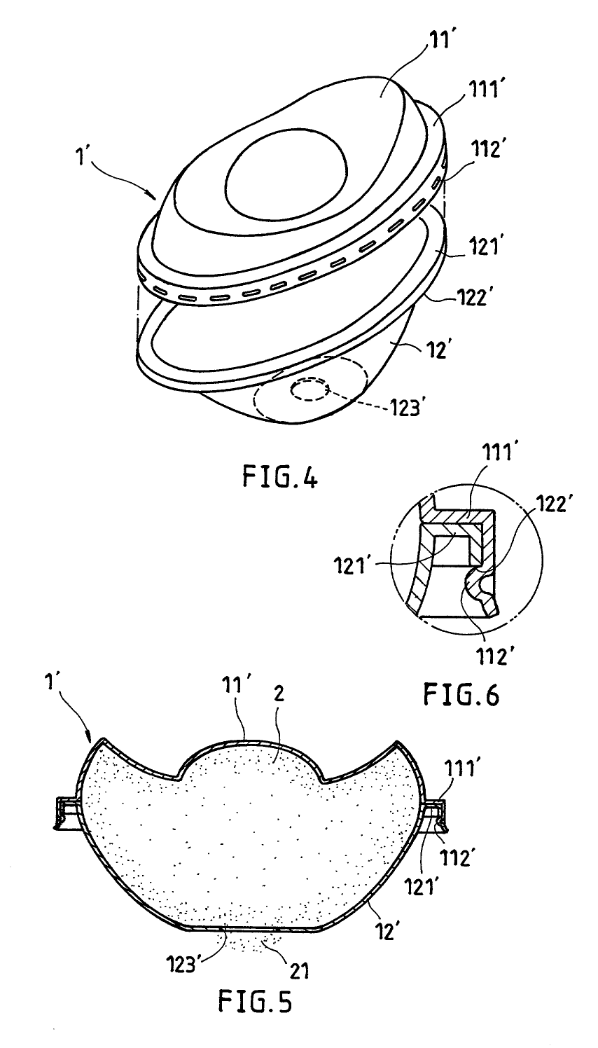

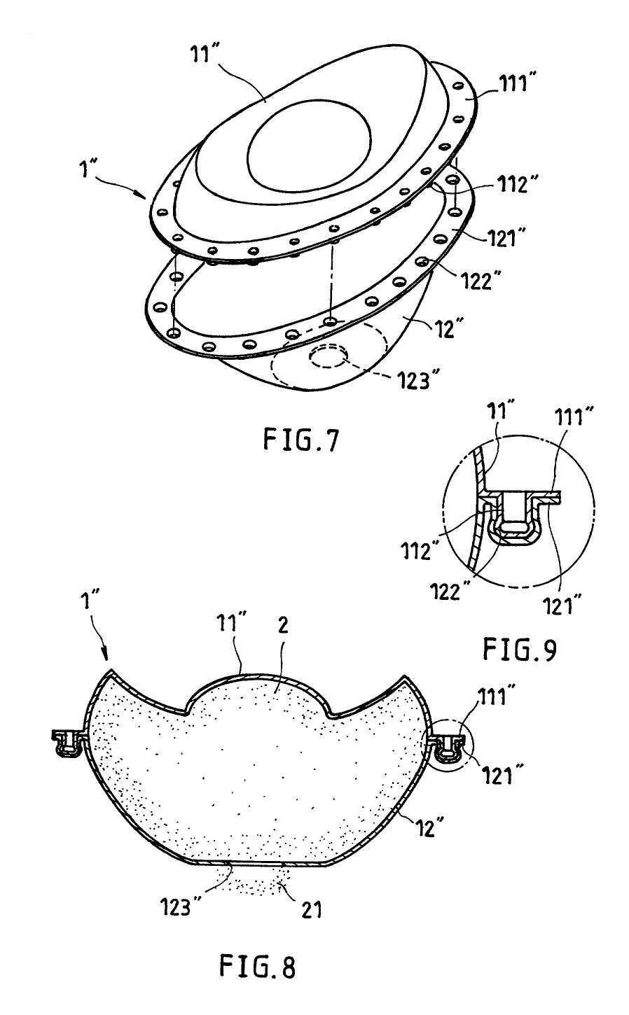

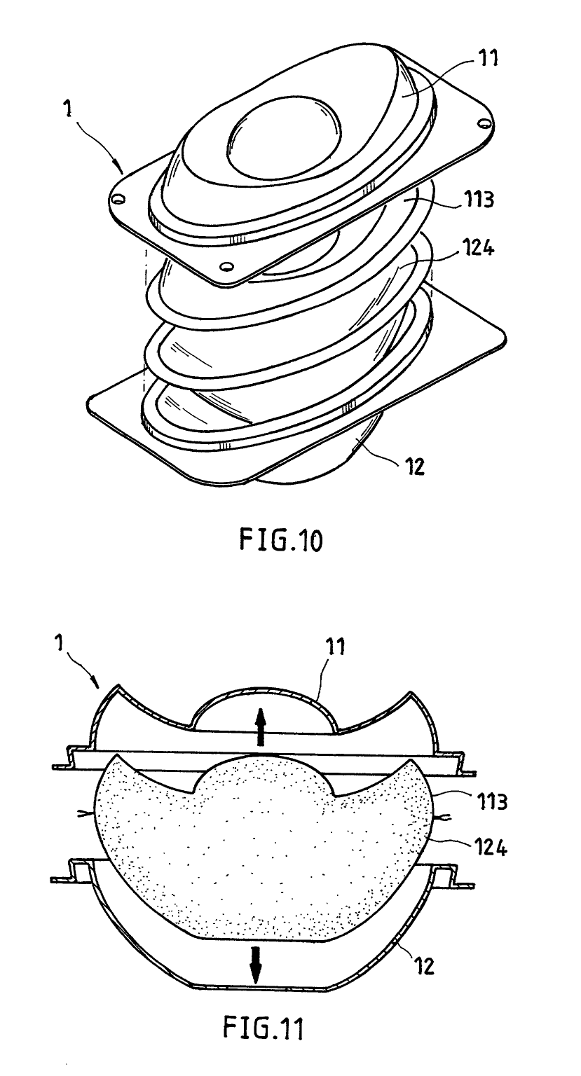

Referring to FIGS. 10 and 11 and FIG. 1 again, a first thin sheet of stripping material 113 and a second thin sheet of stripping material 124 are provided fitting the upper die 11 and the bottom die 12 respectively. Before molding, the first thin sheet of stripping material 113 and the second thin sheet of stripping material 124 are respectively fitted into the upper die 11 and the bottom die 12. After molding, the first thin sheet of stripping material 113 and the second thin sheet of stripping material 124 are secured to the molded raw food (dough), protecting the molded raw food (dough) against contamination. The thin sheet of stripping material 113 and 124 can be non-toxic plastic films, metal foils, or sheets of paper.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A mold comprising a bottom die, and an upper die closed on said bottom die and defining with said bottom die a cavity for folding molding food materials into a predetermined shape, wherein said upper die comprises a flat bearing wall outwardly extended around said cavity, an endless coupling groove formed in the bearing wall of said upper die around said cavity, and a sloping guide edge extended along an outer side of said endless coupling groove; said bottom die comprises a flat bearing wall outwardly extended around said cavity and fitted over the flat bearing wall of said upper die, an endless coupling flange formed in the bearing wall of said bottom die around said cavity and adapted for engaging into the endless coupling groove of said upper die, a sloping guide edge extended along an outer side of said endless coupling flange and fitting over the sloping guide edge of said upper die, and an overflow outlet through which an overflow of inserted food passes to the outside of said mold.

2. A mold comprising a bottom die, and an upper die closed on said bottom die and defining with said bottom die a cavity for folding molding food materials into a predetermined shape, wherein said upper die comprises a coupling flange extended around said cavity, and a plurality of raised retaining portions equiangularly protruded from an inner surface of the coupling flange of said upper die; said bottom die comprises a coupling flange extended around said cavity and fitted into the coupling flange of said upper die, a plurality of recessed retaining portions equiangularly formed in an outer surface of the coupling flange of said bottom die and adapted for engagement with the raised retaining portions of said upper die, and an overflow outlet through which an overflow of inserted food passes to the outside of said mold.

3. A mold comprising a bottom die, and an upper die closed on said bottom die and defining with said bottom die a cavity for folding molding food materials into a predetermined shape, wherein said upper die comprises a coupling flange extended around said cavity, and a plurality of retaining rods equiangularly downwardly extended from a bottom surface of the coupling flange of said upper die; said bottom die comprises a coupling flange extended around said cavity and fitted over the coupling flange of said upper die, a plurality of retaining holes equiangularly formed in the coupling flange of said bottom die and adapted for receiving the retaining rods of said upper die respectively, and an overflow outlet through which an overflow of inserted food passes to the outside of said mold.

4. The mold as claimed in claim 1 further comprising a first thin sheet of stripping material and a second thin sheet of stripping material respectively attached to said upper die and said bottom die around said cavity and adapted for adhering to the food material under molding and for protecting the molded food material against contamination.

5. The mold as claimed in claim 4 wherein said first thin sheet of stripping material and said second thin sheet of stripping material are made of non-toxic plastics.

6. The mold as claimed in claim 4 wherein said first thin sheet of stripping material and said second thin sheet of stripping material are made of metal foils.

7. The mold as claimed in claim 4 wherein said first thin sheet of stripping material and said second thin sheet of stripping material are made of sheets of paper.
